(19) United States
(12) Patent Application Publication
(10) Pub. No.: US 2009/0045675 A1
(43) Pub. Date: Feb. 19, 2009

(54) Vehicle Theft Prevention Apparatus and Method Utilizing a Transmission Signal

(76) Inventor: Gerald J. Novak, North Caldwell, NJ (US)

Correspondence Address: Law Office of Michael J. Feigin, 306 Howard Ave, Flr 3, Passaic, NJ, 07055, US

(21) Appl. No.: 12/187,470

(22) Filed: Aug. 7, 2008

Related U.S. Application Data
(60) Provisional application No. 60/964,713, filed on Aug. 14, 2007.

(51) Int. Cl. B60R 25/04; A01K 15/00; B60R 25/00

(52) U.S. Cl. 307/10.5; 119/720; 307/10.2; 307/10.3

(57) ABSTRACT

The invention disclosed is a device and system for disallowing unauthorized egress of a movable from a location comprising a wire transmitting a transmission signal, a receiver on the movable for receiving the transmission signal, a detector for detecting the movable, a movement inhibiting device in communication with the receiver causing inhibition of movement of the movable upon the receiver receiving the transmission signal, and a mechanism for disabling the inhibition, the mechanism activated at least when the movable is detected by the detector.

THIS APPLICATION CLAIMS PRIORITY TO PROVISIONAL U.S. APPLICATION SER. NO. 60/964,713 FILED AUG. 14, 2007.

### BACKGROUND OF THE INVENTION

Auto theft is a common crime around the world and one that is costly to owners of vehicles as well as their insurance companies. According to the Federal Bureau of Investigation's Uniform Crime Reports, over 1.1 million cars are stolen every year in the United States. There is a compelling economic, social, and emotional need to reduce the number of auto thefts.

Many auto thefts occur from parking lots, parking garages, and other private property. In some cases, a person may have rightful access to a vehicle, but is not authorized to remove the vehicle from the premises such as a valet parking attendant or worker at a car dealership or car rental facility. Unfortunately, at such places, thefts and other unauthorized usages, such as joyriding, of vehicles is still common.

On some lots, to prevent theft, “tiger teeth” are used to prevent a vehicle from traveling over a path such as an exit until authorized. An example of tiger teeth may be found in U.S. Pat. No. 7,264,417 to Nasatka. However, tiger teeth have limited applications and many drawbacks. First, tiger teeth cause damage to at least the tires of a vehicle. Second, even after the vehicle is damaged, in many cases, it is still possible for the thief to continue driving and stealing the vehicle. Third, tiger teeth can be circumvented by placing blankets and/or boards over the teeth and driving over the blankets and/or boards. While providing a little more difficulty for the thief, the car is still stolen.

Fourth, tiger teeth cannot cover an entire property. In many instances, there are curbs that can be jumped or other places of egress, such as non-paved areas, which may allow a thief to escape with a car. Fifth, the cost of tiger teeth is expensive. Some teeth are upwards of $30,000 or $50,000 each and must be replaced as the teeth become dull or the mechanical mechanism stops working over time. Teeth require monthly maintenance, cleaning, greasing, and so forth, and have a maximum life of about five years in colder climates. The cost and time input is prohibitive. Sixth, tiger teeth are a nuisance to pedestrians who must avoid them and to land owners and business operators who must post warning signs.

While “invisible fence” systems have been known in the art, such as are taught in U.S. Pat. No. 5,465,687 to Custer. Such systems function by providing electric shocks to animals upon crossing over a wire emitting predefined radio waves. While this may be applied to vehicles (see, for example, U.S. Pat. No. 5,503,059 to Pacholok teaching a method disabling a vehicle using a capacitive discharge), this causes damage to the vehicle. U.S. Pat. No. 5,053,768 to Dix, Jr. applies the invisible fence concept to a golf cart wherein an alarm is provided if the cart exits a defined perimeter and eventually, the forward motion of the vehicle is disabled.

However, such a system leaves the vehicle operational and would not, in and of itself, prevent a thief from stealing the vehicle. Further, by providing a warning alarm before administering a shock or disabling of forward motion of a vehicle, this alerts either the animal or thief to move faster out of the defined area to avoid a shock or disabling of forward motion, respectively. In real world trials, a beagle named Maggy ran straight through the invisible fence at high speeds to avoid a shock and would remain in the street to avoid the possibility of a shock on the return trip. A thief, not desiring a return trip, would also remove a vehicle from a designated area by moving at a high speed to escape the reach of the radio signals before the forward motion could be disabled, or, in the alternative, drive the vehicle backwards out of the area.

Thus, what is needed is a method or apparatus to prevent a vehicle from exiting from a designated area, such as a parking lot, when unauthorized, but allow the vehicle to be returned.

### SUMMARY OF THE INVENTION

It is therefore an object of the invention to provide a device and method for preventing unauthorized egress from a designated location while allowing ingress.

In an embodiment of the invention, a system for disallowing unauthorized egress of a movable (such as a vehicle or animal) from a location comprises a wire transmitting a transmission signal, a receiver on said movable for receiving said transmission signal, a detector outside of said location for detecting said movable (such as a ground loop detector, GPS system, or second wire transmitting and/or receiving a second transmission signal), and a movement inhibiting device (such as shocking device, an engine disabling device, or fuel line closure) in communication with the receiver causing inhibition of movement of the movable upon the receiver receiving the transmission signal, and a mechanism for disabling the inhibition, the mechanism activated at least when the movable is detected by the detector. In this manner, unauthorized egress is prohibited while ingress is permitted.

In an embodiment of the invention, the movable is an animal and the movement inhibiting device is a shocking device. In another embodiment of the invention, the movable is a vehicle and the inhibition is caused by disabling an engine of the vehicle, causing the vehicle, in an embodiment of the invention, to decrease in speed to a stop. The detector may be a ground loop detector such as a loop placed outside of an entrance to the location.

The mechanism for disabling (i.e. overriding) the inhibition may be a manual override switch. Such a switch may be a wireless keypad device, a wired keypad device, a switch under the hood of a vehicle, and a transmission signal power switch (i.e. to turn off the transmission signal propagating through the wire). The mechanism may also be a time delay switch such as a switch configured to re-enable a vehicle after a specified time period, such as 10 or 15 minutes.

In an embodiment of the invention, a device for disabling an engine of a vehicle comprises a receiver located on the vehicle for receiving a transmission signal, and a buried wire transmitting the transmission signal, wherein the engine is disabled upon the receiver receiving the transmission signal unless a predefined condition is met. The predefined condition may be detection of the vehicle outside of a designated area such as via a ground loop detector, a camera, a wireless receiver, or a global positioning system. The predefined condition may comprises entry of a code, raising of an exit gate, reading data from a card, disengaging of tiger teeth, and/or waiting a predefined period of time, such as between 5 and 60 minutes. The buried wire may comprise a plurality of segments of buried wire. The buried wire may be operatively coupled with a plurality of transmitters.

### BRIEF DESCRIPTION OF THE DRAWINGS

FIG. 1 shows an overview of the system and device of an embodiment of the invention.

FIG. 2 shows inset 140 of FIG. 1 and shows an entrance/exit from a location in an embodiment of the invention.

FIG. 3 shows a configuration of a system and method for inhibiting movement of a movable in an embodiment of the invention.

FIG. 4 shows a configuration of a system and a method for inhibiting movement of a movable in a further embodiment of the invention.

FIG. 5A shows a high level block diagram of a transmitter used in an embodiment of the invention.

FIG. 5B shows a high level block diagram of a receiver used in an embodiment of the invention.

FIG. 6 shows a high level drawing of a system for disabling a vehicle in an embodiment of the invention by cutting a fuel supply.

FIG. 7 shows a high level drawing of a system for disabling a vehicle in an embodiment of the invention by disabling an electrical system.

FIG. 8 shows a high level drawing of a system for disabling a vehicle in an embodiment of the invention by engaging a braking system.

FIG. 9 shows a high level drawing of a system for disabling a hybrid vehicle in an embodiment of the invention by disabling an electrical system.

FIG. 10 shows a high level block diagram of a device on which aspects of the invention may be carried out.

### DETAILED DESCRIPTION OF THE EMBODIMENTS

The invention disclosed is a device and system for disallowing unauthorized egress of a movable from a location comprising a wire transmitting a transmission signal, a receiver on the movable for receiving the transmission signal, a detector for detecting the movable, a movement inhibiting device in communication with the receiver causing inhibition of movement of the movable upon the receiver receiving the transmission signal, and a mechanism for disabling the inhibition, the mechanism activated at least when the movable is detected by the detector.

The embodiments of the invention will become clearer when considered in conjunction with the following description of the figures.

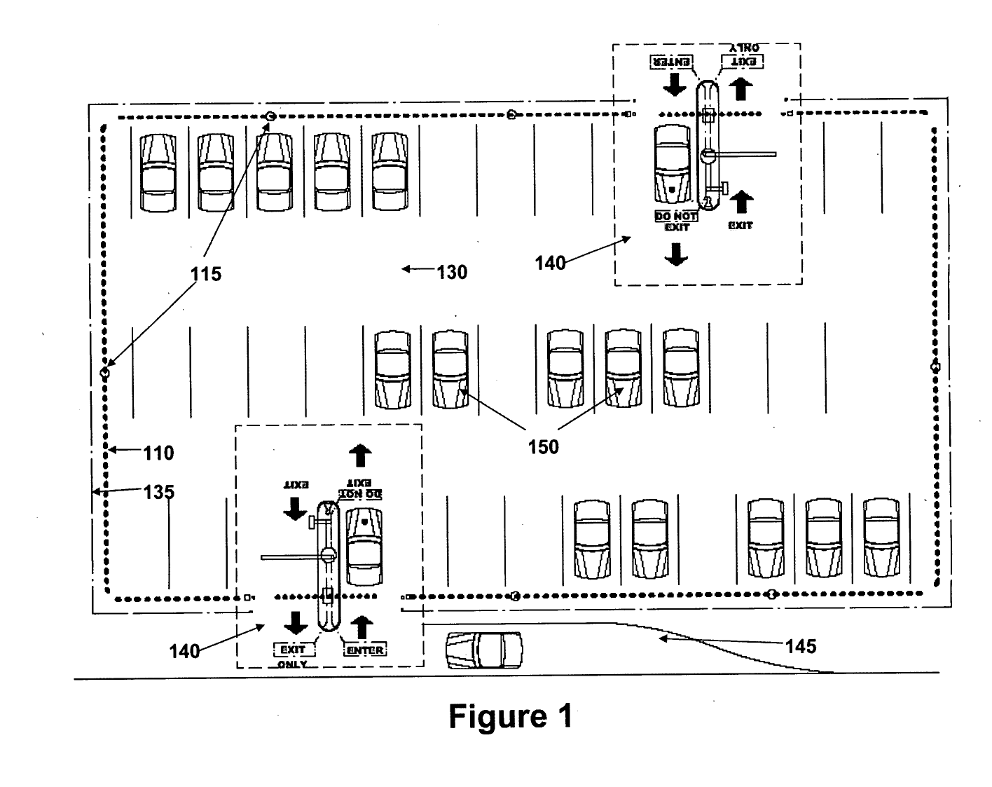

FIG. 1 shows an overview of the system and device of an embodiment of the invention. Parking lot 130 is a location where it may be desired to protect cars from unauthorized egress. Substantially any location, such as a garage, a parking deck, a parking lot, a physical structure, a private property, a public property, or a combination thereof may designated as a location where part or all of the systems and methods of the inventions may be utilized. The parking lot 130 may be surrounded by a perimeter fence 135 or other types of walls to prevent unauthorized removal of vehicles or other movables (items capable of being moved) from the premises.

A wire 110 transmitting a radio signal, as is generally known in the art, abuts the perimeter. The wire 110 may be inside or outside of the perimeter of the location and at periodic or other intervals may have transmitters 115 by which the signal in the wire 110 originates or is amplified/modified. The spaced apart transmitters 115 add security because if part of a wire 110 is cut or disabled, the other lengths of wire 110 will still be functional. The wire 110 is typically buried beneath the surface of the ground in embodiments of the invention.

Cars 150 or other movables comprise or are attached to a receiver for receiving a signal transmitted by a wire 110. The cars 150 may enter and exit from the road 145 or other area outside of the location protected via entrances 140. Any number of entrances may be provided, each one comprising means, as will be described below, for detecting authorized and/or unauthorized ingress and egress of a movable such as a vehicle.

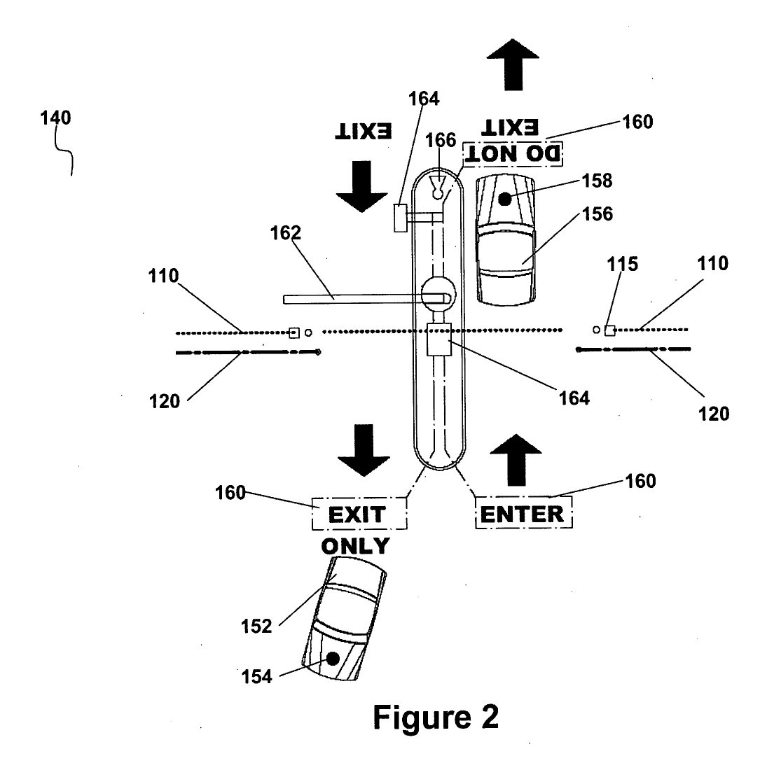

FIG. 2 shows inset 140 of FIG. 1 and shows an entrance/exit from a location in an embodiment of the invention. Wire 110 extends to the entrance, i.e. the space between the fences 120 or other area designated for a car or other movable to pass through. The wire 110 may also extend across the entrance to the protected location but is generally part of a portion of a wire extending only across the entrance so that transmission from this section of wire may be disabled, while still having the other sections of wire enabled.

Device 158 is attached to or part of a vehicle or other movable and as a radio receiver or other mechanism for receiving a signal transmitted from the wire. The device 158 is configured to disable (slow, shock, turn off, cut an energy source, or otherwise inhibit movement of a movable) a vehicle, living organism, or other movable or the mechanism used to move the movable upon receiving a signal transmitted through the wire 110. The device 158 will be explained in greater detail below.

Referring again to FIG. 2, an entering vehicle 156 passes over a ground loop detector 160 as is commonly known in the art for detecting the presence of a vehicle. Upon detection of an entering vehicle, at least a portion of the signal being transmitted from the wire 110 is disabled in embodiments of the invention where the wire 110 passes across an entrance. This allows a vehicle to enter the location without being disabled. A second ground loop detector 160 (at the “DO NOT ENTER”) may be placed after the entrance to detect when the vehicle has successfully entered the location and the signal being transmitted from wire 110 can be and/or is re-enabled.

Such a device 158 may also comprise a transmitter such that when the device 158 receives a signal, rather than disable the movable instantaneously, the device 158 transmits a second signal and waits for a response from a second transmitter, such as a higher power and longer range transmitter at the location within or near the wire 110 in order to ensure that the received signal is not erroneous. Thus, upon receiving a transmitted signal, device 158 may transmit a second signal querying another device for a response. Only upon receiving such a response to the query, in embodiments of the invention, the device disables the movable. Another mechanism for validation that the movable should be disabled include providing an alarm to an owner or operator a parking lot or other location to alert such a person of a possible breach (such as by wired or wireless communication which may be a sound alarm, a text message, or the like) and receiving a response from that person to disable the vehicle through a second transmission.

In addition to a security fence 120 and wire 110 connected to one or a plurality of transmitters 115, various security mechanisms may be used in conjunction with the invention. In addition to the disabling of a movable upon such a movable coming near or crossing a boundary of a pre-defined location, items such as an alarm 166, card reader 164, and gate 162 may be utilized to prevent unauthorized egress. When a vehicle or other movable, such as vehicle 152 approaches a designated exit, a driver or passenger must successfully de-activate the security measures to allow the vehicle or other movable to exit from the location in embodiments of the invention. In such a case, the gate 162, when used, typically goes up, tiger teeth, as described in the background of the invention, are disabled, and so forth. When such security measures are de-activated, or any other security measures known in the art are deactivated, the movable may be authorized for egress and as such, the devices, systems, and methods of the invention, may be disabled so that the movable is allowed to egress. Such devices, systems, and methods of the invention may also be disabled when a movable is detected on the outside of the location it is not desirable to disable the movable upon ingress.

For example, a card reader 164 may be operatively configured to disable or override methods, systems, and devices of the invention which disable a movable. Upon successfully swiping a card with a monetary balance encoded thereon, a credit card, or an exit pass, the transmission of a signal from the wire may be temporarily disabled or a verification system configured to verify that a movable should be disabled will indicate or fail to pass on information to disable the movable.

In another example of disabling or overriding the mechanism so as to allow a movable to egress, a gate 162 may be used. Upon sensing that a car is approaching, such as by using a ground loop detector, motion detector, an electric signal sent via the card reader 164, or raising of a gate by, for example, a worker situated within a booth, the gate 152 is raised and at least a part of the signal being transmitted through the wire 110 is disabled or the verification system is disabled as described above.

A control box 164 may be used to control the transmitters 115 and/or transmit a signal through the wire 110. The control box may be operatively configured to detect unauthorized ingress or egress of a movable, disable or enable a transmission signal, and/or make a determination to inhibit or re-enable (uninhibit) a movable or other element of the invention. The control box 164 may receive inputs and provide output with a user or electrical device to allow a user or an electrical device to determine whether the movable should be inhibited when a signal is received by a receiver on a movable. A determination may be based upon whether an override of a disabling mechanism has been triggered or a condition has been met, such as the detection of a movable near a wire 110 when the gate 162 is in the down position or a card reader 164 has not sent a signal indicating that a driver of a vehicle has not disabled security, or any of the other conditions described above.

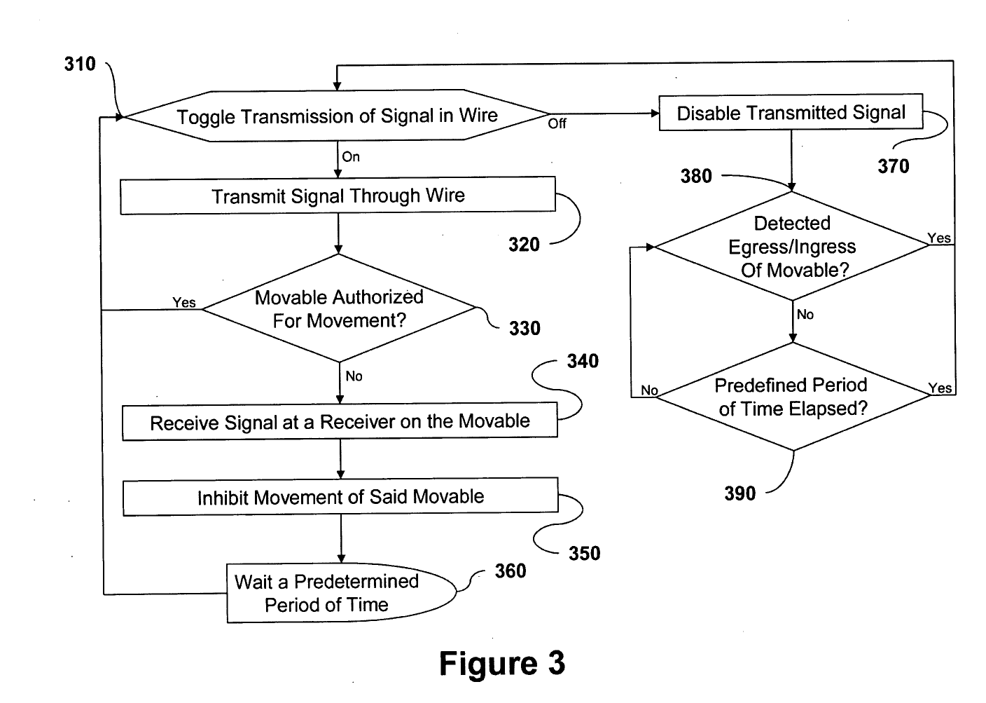

Referring now to FIGS. 1-3 in general, and FIG. 3 in specific, FIG. 3 shows a configuration of a system and method for inhibiting movement of a movable in an embodiment of the invention. In step 310 the transmission of a signal in a wire (as described above) is toggled. In the first instance, the system is off or non-operative and is turned on or made operative. When the transmission signal is turned off or made non-operative, this may be accomplished in part of the wire (such as near or at an entrance 140) or in the entire wire.

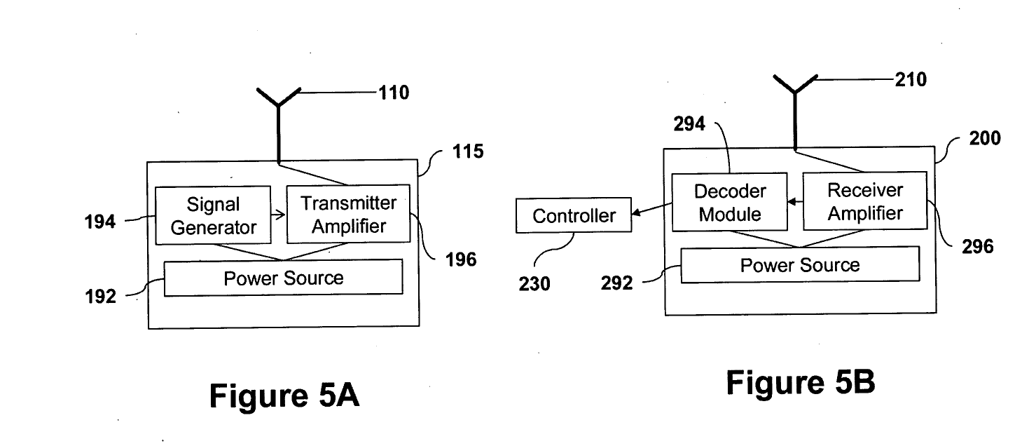

When the transmission is turned on or made operative, in step 320 a signal is transmitted through a wire as described previously. In step 330, if a movable is not authorized for movement, then the system or method proceeds to step 340 whereby the transmitted signal is received on the movable in step 340 such as by a receiver 200 (shown in FIG. 5B). This may occur immediately or after some time. For example, the transmission of a signal through the wire in step 320 generally continues throughout steps 320 through 360. At any time when these steps are being carried out, if a receiver on a movable receives a signal in step 340, then step 350 is carried out whereby movement of the movable is inhibited or disabled. This may be accomplished by, for example, sending an electric shock to the movable if the movable is an animal or a vehicle, disabling the engine of a vehicle, engaging the brakes of a vehicle, or disabling the power source or energy source of a movable.

In step 360, a predetermined period of time passes until the transmission of the signal in the wire is disabled by returned to step 310 wherein the signal transmission is toggled. Alternatively, a controller (such as controller 230 of the receiver 200, as depicted in FIG. 5B) may remove such inhibition of the movable. This may occur after a preset period of time, such as a fraction of a second to a few seconds if the movable is an animal or 5 minutes, 15 minutes, 60 minutes, or any range there between if the movable is a vehicle. In this manner, if a movable is disabled or inhibited from moving improperly, then the movable will be re-enabled after a period of time.

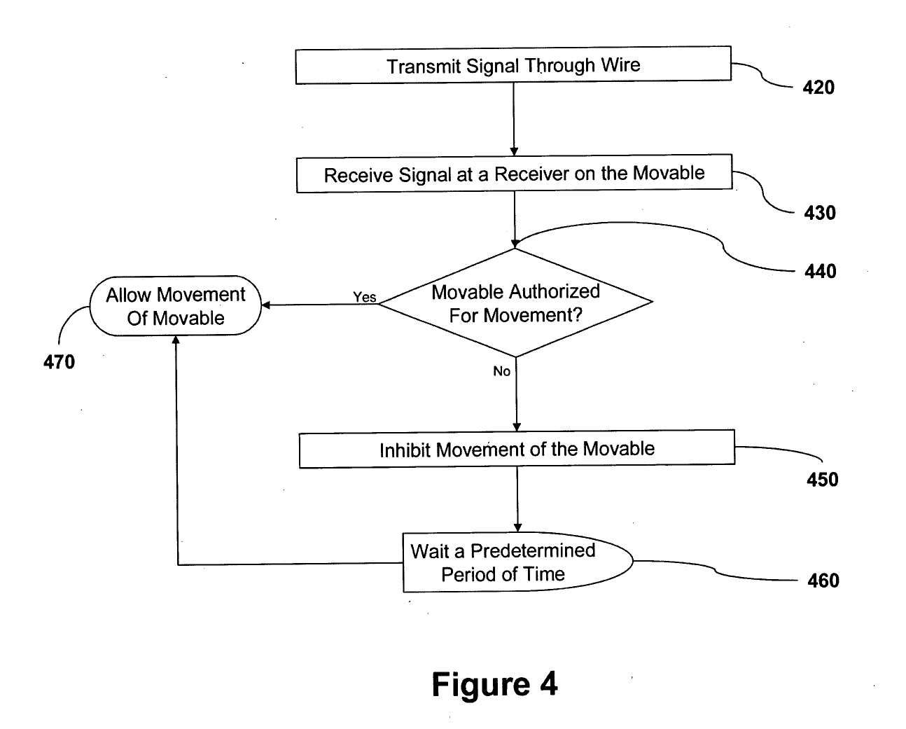

Referring again to step 330, a movable may be authorized for movement when any of the aforementioned security features as described with reference to FIG. 2 are used. For example, when the gate 162 is lifted in connection with use of a card reader 164 or an attendant, the movable may be authorized for egress, in embodiments of the invention. In addition, various wired and wireless devices may be used to authorize movement. For use in a valet parking lot or paid lot where others have access to drive a vehicle, it may be desired to have a wireless device, such as on a keychain, or a pin code operated device within the vehicle which allows movement of a vehicle out of a location by disabling the transmission signal (or disabling a mechanism or device for inhibiting movement of the vehicle as will be described with reference to FIG. 4). In this manner, another driver may operate the vehicle freely within a parking lot or other location, but cannot remove the car from such a location.

In another example where a movable is authorized for movement in embodiments of the invention, the movable is outside of the location and seeks entry. For example, an animal may be outside of the area contained by a buried wire or a vehicle may be on a road outside of a parking lot which is surrounded by a buried wire. In each case, the buried wire may transmit a signal which can be received by a receiver on the movable. It may be detected that the movable is outside of the location by using a sensors known in the art, such as a ground loop detector 160, a motion sensor, a weight sensor, and the like.

When a movable is authorized for movement in step 330, then step 310 is carried out whereby the transmission of the signal in the wire is toggled. In this case, the transmission was on, so the toggling turns off the transmission of the signal and step 370 is carried out.

In step 370, the transmitted signal is disabled. Then, in step 380, if egress or ingress (depending on the whether the movable started inside the location to be protected or outside the location to be protected, respectively) of a movable is detected when the movable, then the transmission of the signal in the wire is toggled again in step 380 whereby it is turned back on or made operative again. The detection of the movable may again be by way of a ground loop detector 160, a motion sensor, a weight sensor, and the like. In this manner, upon egress of the vehicle, the system is re-enabled so as not to allow another vehicle, animal, or other type of movable to exit unauthorized.

If the movable is not detected in step 380, then after a predefined period of time has elapsed in step 380, the signal wire transmission will toggled so that the signal is transmitted through the wire again in step 320. If a predefined period of time has not elapsed, then step 380 is repeated until egress/ingress is detected. Steps 380 and 390 will repeat in a loop until either the ingress or egress of the movable is detected or a predefined period of time elapses. The time to elapse may be a part of a second, 1 second, 5 seconds, 10 seconds, 15 seconds, 30 seconds, 1 minute, 5 minutes, or any range therebetween.

FIG. 4 shows a configuration of a system and a method for inhibiting movement of a movable in a further embodiment of the invention. In this system and method, a controller may be utilized to decide whether to disable or inhibit movement of a movable. Such a controller may be a controller 230 depicted in FIG. 5 and described below, or a controller 164 of FIG. 2. The controller, or other device, local circuit, or human, may be part of a mechanism on the movable, an external mechanism, or a manual decision on the part of an operator, such as a parking attendant. For example, an alarm may be triggered by the receipt of a transmitted signal from a wire as a movable egresses from a location unauthorized and a parking lot attendant may hear the alarm and decide to inhibit movement of movable by transmitting a second signal to disable the movable. This will become more clear in light of the description of FIG. 4.

As in the embodiment of FIG. 3, in FIG. 4, a signal is transmitted through a wire in step 420. A receiver on the movable receives the signal in step 430. If the movable is authorized for movement, such as egress, then the method and system proceeds to step 470 where the movable is allowed to move. Thus, despite the receipt of a signal transmitted signal through a wire, such as a buried wire around the perimeter of a location such as a parking lot, private property, and so forth, the movable is allowed to continue moving when it is authorized to do so. This may be the case when, for example, an operator of a movable or parking attendant enters a code into a wired or wireless device which signals to a controller (such as controller 200 depicted in FIG. 5B) indicating the movement of the movable is permissible. A controller may also be configured to disable a movement based on a time of day, so as to allow egress during business hours, but prevent any egress during late hours of the night when egress is forbidden are vehicles are most likely to be stolen. Other factors which may allow for a movable to be authorized for movement has been described with reference to FIGS. 2 and 3. Such factors are also applicable with respect to systems and methods shown in FIG. 4 and vice versa.

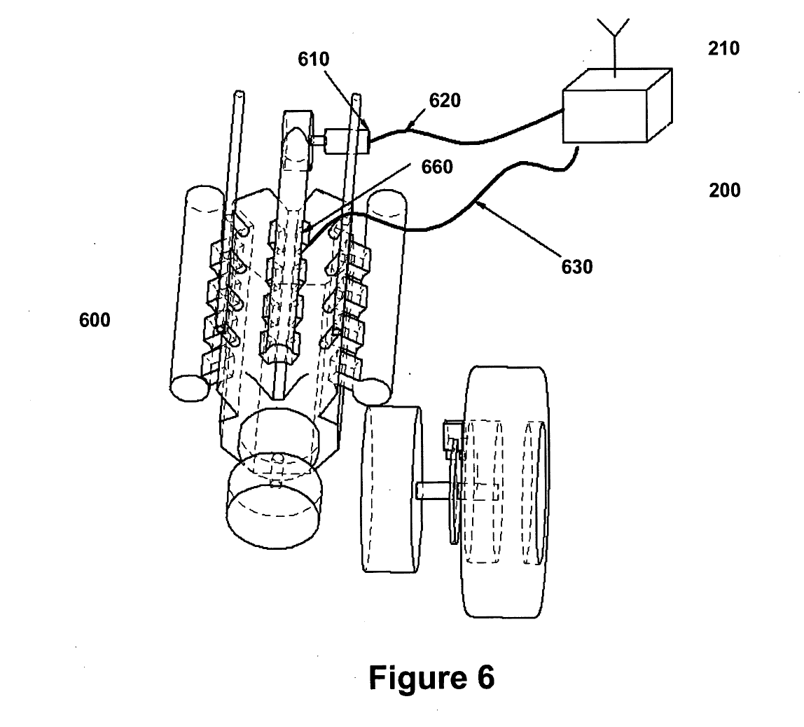

If the movable is not authorized for movement, then step 450 is carried out whereby movement of the movable is inhibited by any of the methods described herein above or as shown and described with reference to FIGS. 6-9. In embodiments of the invention, step 460 is carried out whereby the inhibition is for a designated period of time, such as described in reference to step 380 of FIG. 3. Then, step 470 is carried out and the movable may be moved.

FIG. 5A shows a high level block diagram of a transmitter used in an embodiment of the invention. One or a plurality of transmitters 115 may be operatively connected to a wire 110 enclosing a perimeter, an entrance, an exit, or any area where it is desired to prevent a movable from crossing and coming near. The transmitter has a power source 192 as is known in the art which provides current to a signal generator 194 and amplifier 196, the signal generator sending a signal to the amplifier 196. The amplifier 196 sends and/or is operatively connected to a wire 110 for propagating the signal as desired. The signal transmitted may be at a specific frequency and may comprise transmission of analog or digital information, an encrypted or non encrypted code, or the like to be received by a receiver 200.

FIG. 5B shows a high level block diagram of a receiver used in an embodiment of the invention. The receiver comprises an antenna 210 for receiving a signal transmitted by the transmitter 115. An amplifier 296 amplifies the received signal and a decoder module 294 decodes the signal. Both the decoder module 294 and the receiver amplifier 296 are powered by a power source 292. Upon decoding a signal, the decoder module 294 communicates with a controller 230 of receipt of the signal. If the signal is at a correct frequency and/or contains the correct message, then the controller 230 will decide whether to disable or inhibit movement of the movable or will disable or inhibit movement of the movable by way of any of the methods described herein.

FIGS. 6-9 show some of the methods and devices which may be employed to disabled a movable when the movable is a vehicle. The methods and devices may be used individually or in combination. It should be further understood by one skilled in the art that the figures provided are by way of examples of embodiments of the invention and any method of disabling a movable may be used in conjunction with the invention.

FIG. 6 shows a high level drawing of a system for disabling a vehicle in an embodiment of the invention by cutting a fuel supply. A receiver 200 receives a signal via antenna 210 and is operatively connected to or between a fuel tank 610 and a fuel pump 660 of an engine by way of fuel lines 620 and 630. The engine of the vehicle is disabled by either preventing fuel from entering the engine, causing the vehicle to roll to a stop, or by disengaging a fuel pump or an electrical system of the engine allowing for fuel to enter the engine for combustion.

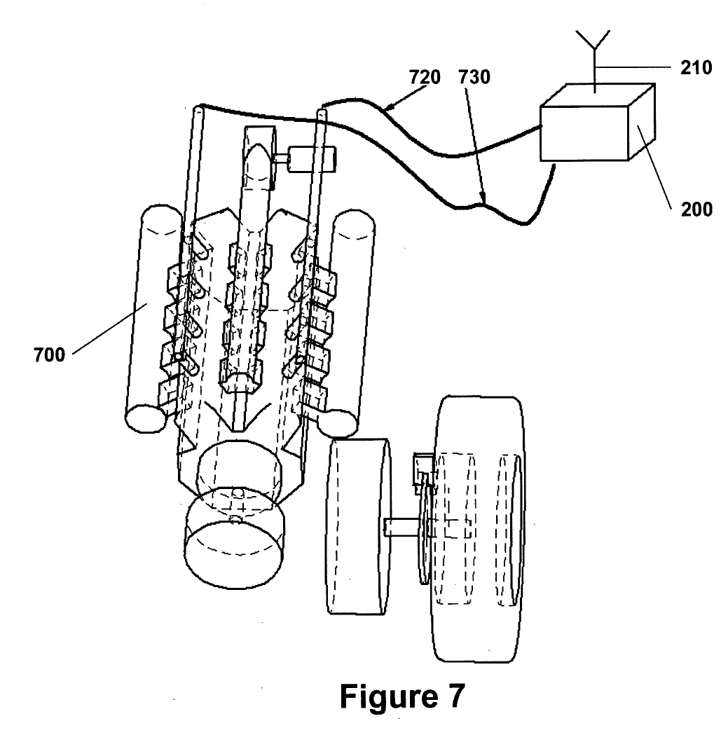

FIG. 7 shows a high level drawing of a system for disabling a vehicle in an embodiment of the invention by disabling an electrical system. Electrical connections between a receiver 200 are made to an engine, for example, by way of wires 720 and 730. When a controller on the receiver 200 receives a signal to disable the vehicle, an electrical system may be shut down on engine 700.

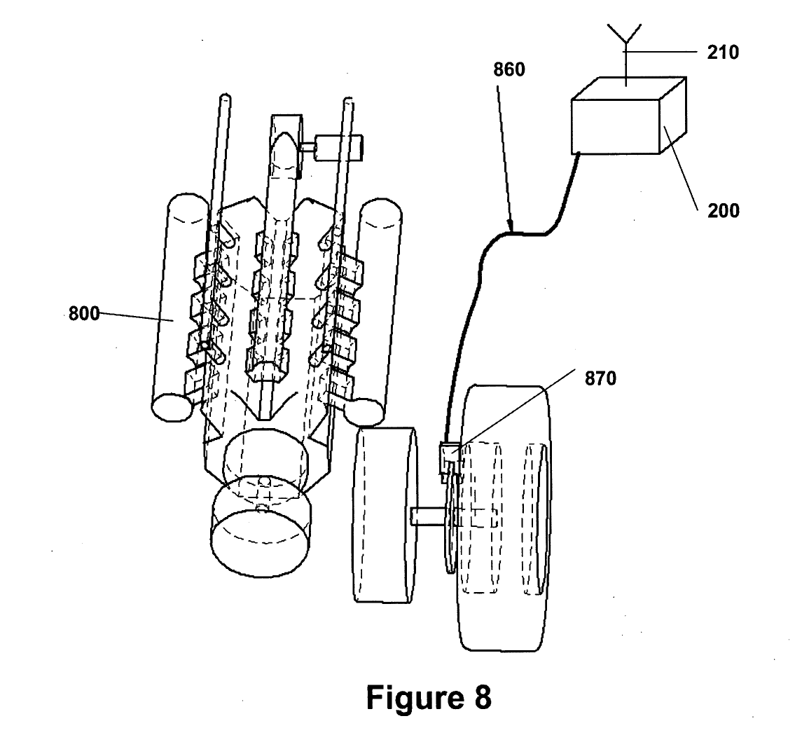

FIG. 8 shows a high level drawing of a system for disabling a vehicle in an embodiment of the invention by engaging a braking system. In this embodiment, the engine 800 is not disabled, though the acceleration may be disabled. Rather, an electrical, hydraulic, or other connection 860 causes at least one or all of the brakes 870 to be engaged in order to prevent movement of a vehicle upon receiving a signal by way of receiver 200.

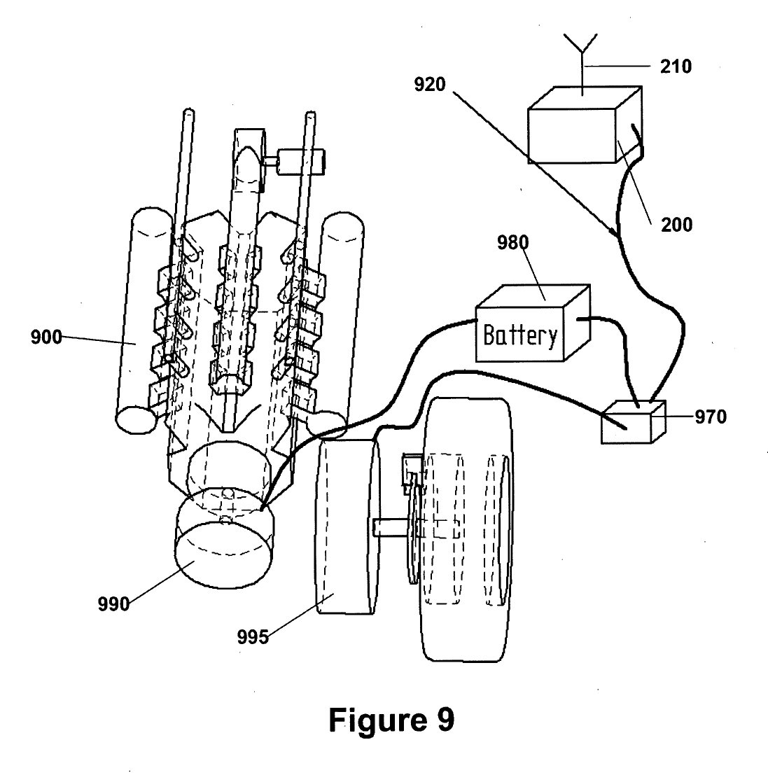

FIG. 9 shows a high level drawing of a system for disabling a hybrid vehicle in an embodiment of the invention by disabling an electrical system. In a hybrid vehicle, the vehicle is powered by both a battery and an engine and comprises a computer controller 970 to determine when to use which power source. The controller 230 of the receiver 200 may be implemented on a controller 970 of a hybrid vehicle (or a controller of any other vehicle). The controller 270 or 970 is may disable the vehicle by way of an electrical connection, such as connection 920 or a connection between controller 970 and a battery 980, engine 900, or braking system 995. In this manner, the battery 980 and/or the engine 990 may be disabled to inhibit movement of the vehicle, and/or the braking system 995 may cause the wheels to remain locked to prevent movement of the vehicle.

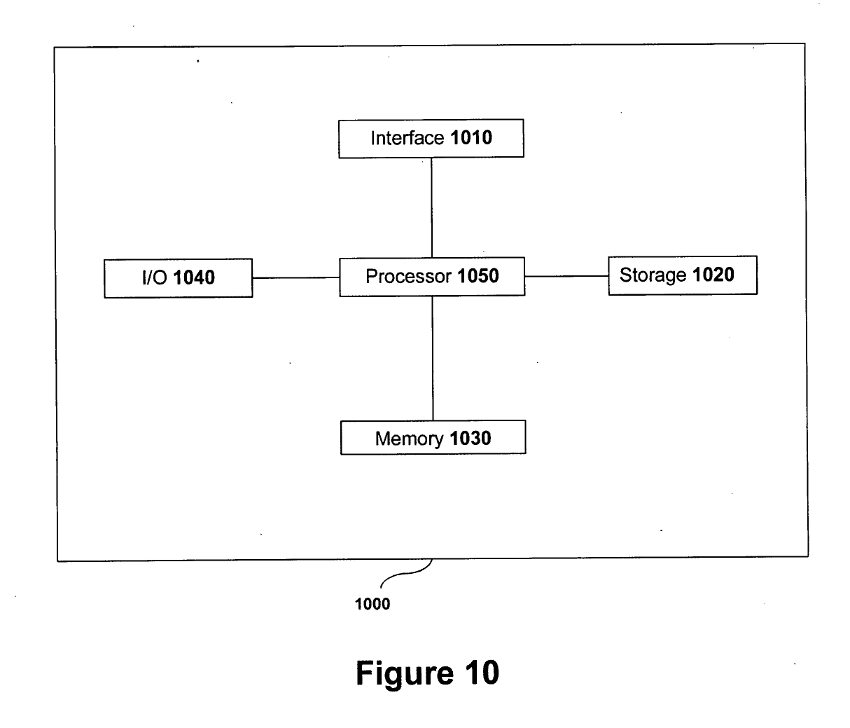

FIG. 10 shows a high-level block diagram of a computer that may be used to carry out the invention. Computer 1000 contains a processor 1050 that controls the overall operation of the computer by executing computer program instructions which define such operation. The computer program instructions may be stored in a storage device 1020 (e.g., magnetic disk, database) and loaded into memory 1030 when execution of the computer program instructions is desired. Thus, the computer operation will be defined by computer program instructions stored in memory 1030 and/or storage 1020, and the computer will be controlled by processor 1050 executing the computer program instructions. Computer 1000 also includes one or a plurality of input network interfaces for communicating with other devices via a network (e.g., the Internet). Computer 1000 also includes one or more output network interfaces 1010 for communicating with other devices. Computer 1000 also includes input/output 1040 representing devices which allow for user interaction with the computer 1000 (e.g., display, keyboard, mouse, speakers, buttons, etc.). One skilled in the art will recognize that an implementation of an actual computer will contain other components as well, and that FIG. 10 is a high level representation of some of the components of such a computer for illustrative purposes. It should also be understood by one skilled in the art that the method and devices depicted in FIGS. 1 through 9 may be implemented on a device such as is shown in FIG. 10.

While the invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

I claim:

1. A system for at least partially inhibiting movement of a movable configured to carry out the steps of:
transmitting a signal through a wire;
receiving said transmitted signal at a receiver on said movable;
inhibiting said movable upon receiving said transmission signal; and
preventing said inhibiting when said movable is authorized for movement.

2. The system of claim 1, wherein said movable is an animal and said step of inhibiting comprises use of a shocking device.

3. The system of claim 1, wherein said movable is a vehicle.

4. The system of claim 3, wherein said inhibiting is caused by disabling an engine of said vehicle.

5. The system of claim 4, wherein said vehicle decreases in speed to a stop.

6. The system of claim 1, wherein said step of preventing comprises disabling said transmitting.

7. The system of claim 3, wherein said step of preventing comprises preventing said disabling of said engine.

8. The system of claim 1, wherein said step of preventing further comprises the use of a device selected from the group consisting of a wireless keypad device, a wired keypad device, a switch under the hood of a vehicle, and a transmission signal power switch.

9. The system of claim 1, further comprising the step of allowing movement of said movable at a predetermined time after said step of inhibiting.

10. A device for at least partially inhibiting movement of a vehicle, comprising:
a receiver located on said vehicle for receiving a transmission signal; and
a buried wire transmitting said transmission signal;
wherein said movement is inhibited upon said receiver receiving said transmission signal unless a predefined condition is met.

11. The device of claim 10, wherein said predefined condition comprises detection of said vehicle outside of a designated area.

12. The device of claim 11, wherein said detection is selected from the group consisting of detection via a ground loop detector, a camera, a wireless receiver, and a global positioning system.

13. The device of claim 10, wherein said predefined condition comprises entry of a code.

14. The device of claim 10, wherein said predefined condition comprises raising an exit gate.

15. The device of claim 10, wherein said predefined condition comprises reading data from a card.

16. The device of claim 10, wherein said predefined condition comprises disengaging tiger teeth.

17. The device of claim 10, wherein said predefined condition comprises waiting a predefined period of time.

18. The device of claim 15, wherein said predefined period of time is between 5 and 60 minutes.

19. The device of claim 10, wherein said buried wire comprises a plurality of segments of buried wire.

20. The device of claim 18, wherein said buried wire is operatively coupled with a plurality of transmitters.
